(19) United States
(12) Patent Application Publication
(10) Pub. No.: US 2004/0263660 A1
(43) Pub. Date: Dec. 30, 2004

(54) Electronic device with mirror function and image capture function

(76) Inventors: Yi-Sheng Wang, Taipei (TW); Ying-Yu Lu, Taichung (TW)

Correspondence Address: BIRCH STEWART KOLASCH & BIRCH, PO BOX 747, FALLS CHURCH, VA, 22040-0747, US

(21) Appl. No.: 10/874,215

(22) Filed: Jun. 24, 2004

(30) Foreign Application Priority Data
Jun. 30, 2003 (TW) 092117865

(51) Int. Cl. H04N 5/222

(52) U.S. Cl. 348/333.01

(57) ABSTRACT

An electronic device with a mirror function and an image capture function comprises a body, a mirror display and an image capture unit. In this case, the mirror display is disposed in the body. The mirror display has a mirror plate and a display panel. The mirror plate is combined with the display panel or is disposed near the display panel. A semi-reflecting layer is disposed above the mirror plate. The image capture unit is disposed in the body.

### BACKGROUND OF THE INVENTION

1. Field of Invention

This invention relates to an electronic device, and more particularly to an electronic device with mirror function and image capture function.

2. Related Art

As technology advances everyday, hand-held electronic products, such as mobile phones, personal digital assistants (PDAs), e-books, stock quote machines and digital still cameras, are also getting more and more diversified. For example, mobile phone with the digital camera function has become a fashionable design. Generally speaking, this type of mobile phone has a lens disposed in its body and image storage media for storing captured photos.

In order to facilitate the user to photograph his/her own image, some mobile phones add a metallic convex mirror to itself. As shown in FIGS. 1A and 1B, the mobile phone 9 has a first body 91, a second body 92, a display 93, an image capture unit 94, a metallic convex mirror 95, and an input unit 96. The display 93, the image capture unit 94 and the metallic convex mirror 95 are all disposed in the first body 91, the input unit 96 is disposed in the second body 92, and the image capture unit 94 includes a lens. When the user takes his/her own picture or image using the mobile phone 9, the metallic convex mirror 95 reflects the user's own image so that the user can make sure his/her image can be captured. However, the user won't be able to know exactly how himself/herself to be photographed by the image capture unit 94 because the convex mirror cannot be precisely provided a correct image preview.

In view of this, another mobile phone design discloses a rotary lens to solve the above-mentioned problem. As shown in FIG. 2A, the mobile phone 10 has a first body 101, a second body 102, a display 103, an image capture unit 104 and an input unit 105. The display 103 and the image capture unit 104 are disposed in the first body 101, and the input unit 105 is disposed in the second body 102. In the mobile phone 10, the image photographed by the image capture unit 104 is directly presented on the display 103. When the user utilizes the mobile phone 10 to photograph himself/herself, the rotatable pivot design may be used to rotate the first body 101, and the display 103 may be used to identify the image that is just photographed, as shown in FIG. 2B. However, this kind of mobile phone has a complicated structure, higher manufacturing cost, and inconvenient operation procedure, so it is disadvantageous to the practical product application.

### SUMMARY OF THE INVENTION

In view of the above-mentioned problems, this invention is to provide an electronic device having a mirror function, an image capture function, a simple structure, and a low manufacturing cost, wherein the electronic device can be operated much more conveniently and can precisely preview the image.

The electronic device of this invention includes, but not limited to, a mobile phone, a hand-held PC, a personal digital assistant (PDA), an e-book, a stock quote machine, a digital voice recorder, a digital still camera, and a digital video recorder (DVR).

In a preferred embodiment of this invention, an electronic device with a mirror function and an image capture function includes a body, a mirror display and an image capture unit. The mirror display is disposed in the body, the mirror display includes a mirror plate and a display panel, the mirror plate is combined with the display panel or disposed near the display panel, and a semi-reflecting layer disposed above the mirror plate. The image capture unit is disposed in the body.

In a preferred embodiment of this invention, an electronic device with a mirror function and an image capture function includes a body, a mirror display and an image capture unit. The mirror display is disposed in the body, and the mirror display includes a mirror plate and a display panel. The mirror plate is combined with the display panel or disposed near the display panel, and a semi-reflecting layer disposed above the mirror plate. The image capture unit is connected to a side of the body.

In a preferred embodiment of this invention, an electronic device with a mirror function and an image capture function includes a first body, a second body, a mirror display and an image capture unit. The second body and the first body are connected to each other. The mirror display is disposed in the first body, and the mirror display includes a mirror plate and a display panel. The mirror plate is combined with the display panel or disposed near the display panel, and a semi-reflecting layer disposed above the mirror plate. The image capture unit is disposed in the first body or the second body.

In a preferred embodiment of this invention, an electronic device with a mirror function and an image capture function includes a first body, a pivot, a second body, a mirror display and an image capture unit. The second body and the first body are connected to each other through the pivot. The mirror display is disposed in first body and includes a mirror plate and a display panel. The mirror plate is combined with or disposed near the display panel, and a semi-reflecting layer disposed above the mirror plate. The image capture unit is disposed in the pivot.

The display panel includes, but not limited to, an organic electroluminescence (OEL) display panel, an electroluminescence (EL) display panel, a light-emitting diode (LED) display panel, a liquid crystal display (LCD), a plasma display panel (PDP), a vacuum fluorescent display (VFD), a field emission display (FED), an electro-chromic display (Electro-chromic Display), and the like.

In a preferred embodiment of this invention, an electronic device with a mirror function and an image capture function includes a body, a mirror display and an image capture unit. The mirror display is disposed in the body and includes a transparent substrate and a semi-reflecting layer. The transparent substrate has a first surface and a second surface opposite to the first surface. The semi-reflecting layer is disposed above the first surface or the second surface. The image capture unit is disposed in the body.

In a preferred embodiment of this invention, an electronic device with a mirror function and an image capture function includes a body, a mirror display and an image capture unit. The mirror display is disposed in the body and includes a transparent substrate and a semi-reflecting layer. The transparent substrate has a first surface and a second surface opposite to the first surface. The semi-reflecting layer is disposed above the first surface or the second surface. The image capture unit is connected to a side of the body.

The mirror display includes, but not limited to, an organic electroluminescence (OEL) display, an electroluminescence (EL) display, a light-emitting diode (LED) display, a liquid crystal display (LCD), a plasma display panel (PDP), a vacuum fluorescent display (VFD), a field emission display (FED), an electro-chromic display, and the like.

As mentioned above, the electronic device of this invention with a mirror function and an image capture function utilizes the mirror display for image preview. More specifically, when the user utilizes the electronic device to take his/her own image, the reflection function of the mirror display can be utilized to make sure the targeted image to be correctly framed and focused. Compared to the prior art, the image preview can be made while photographing without adding extra elements (e.g., the metallic convex mirror in the prior art) or extra operations. Thus, the expense of the additional components can be eliminated. And, the complicated image framing and then photographing operations can be avoided. Also, this invention can provide a precise image preview of the image without utilizing any other display to demonstrate. That is, when the mirror display is disabled from emitting light, the mirror display of the electronic device has the image reflection function like mirror, which in this invention may reflect the user's own image for the purpose of image preview when the self-photographing process is performed. On the other hand, when the mirror display is emitting light, the mirror display of the electronic device has the function of showing the information image and may serve as the typical display. Furthermore, this invention can possess the mirror function by only providing the semi-reflecting layer in the mirror display. Thus, the manufacturing processes are simple and the manufacturing costs are decreased, which is very feasible in the practical mass production.

### BRIEF DESCRIPTION OF THE DRAWINGS

The invention will become more fully understood from the detailed description given hereinbelow illustration only, and thus is not limitative of the present invention, and wherein:

FIGS. 1A and 1B are an arrangement of schematic illustrations showing a conventional mobile phone;

FIGS. 2A and 2B are another arrangement of schematic illustrations showing another conventional mobile phone;

FIG. 3 is a schematic illustration showing an electronic device with a mirror function and an image capture function according to a first embodiment of this invention;

FIGS. 4A and 4B are an arrangement of schematically cross-sectional views showing a mirror display of the first embodiment;

FIGS. 5A and 5B are another arrangement of schematically cross-sectional views showing the mirror display in the first embodiment;

FIGS. 6A and 6B show an arrangement of embodied schematic illustrations of FIG. 3;

FIGS. 7A to 7C are an arrangement of schematic illustrations showing an electronic device with a mirror function and an image capture function according to a second embodiment of this invention;

FIG. 8 is a schematic illustration showing an electronic device with a mirror function and an image capture function according to a third embodiment of this invention;

FIG. 9 is a schematic illustration showing an electronic device with a mirror function and an image capture function according to a fourth embodiment of this invention;

FIG. 10 is a schematic illustration showing an electronic device with a mirror function and an image capture function according to a fifth embodiment of this invention;

FIGS. 11A and 11B are an arrangement of schematically cross-sectional views showing the mirror display in the fifth embodiment of this invention;

FIGS. 12A to 12C are an arrangement of schematic illustrations showing an electronic device with a mirror function and an image capture function according to a sixth embodiment of this invention;

FIG. 13 is a schematic illustration showing an electronic device with a mirror function and an image capture function according to a seventh embodiment of this invention; and

FIG. 14 is a schematic illustration showing an electronic device with a mirror function and an image capture function according to an eighth embodiment of this invention.

### DETAILED DESCRIPTION OF THE INVENTION

The electronic device with a mirror function and an image capture function according to the preferred embodiments of this invention will be described with reference to the accompanying drawings.

The electronic device of this invention with a mirror function and an image capture function will be described by taking the mobile phone as an example.

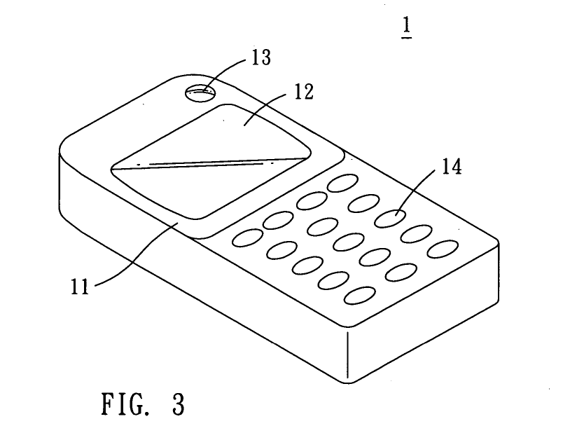

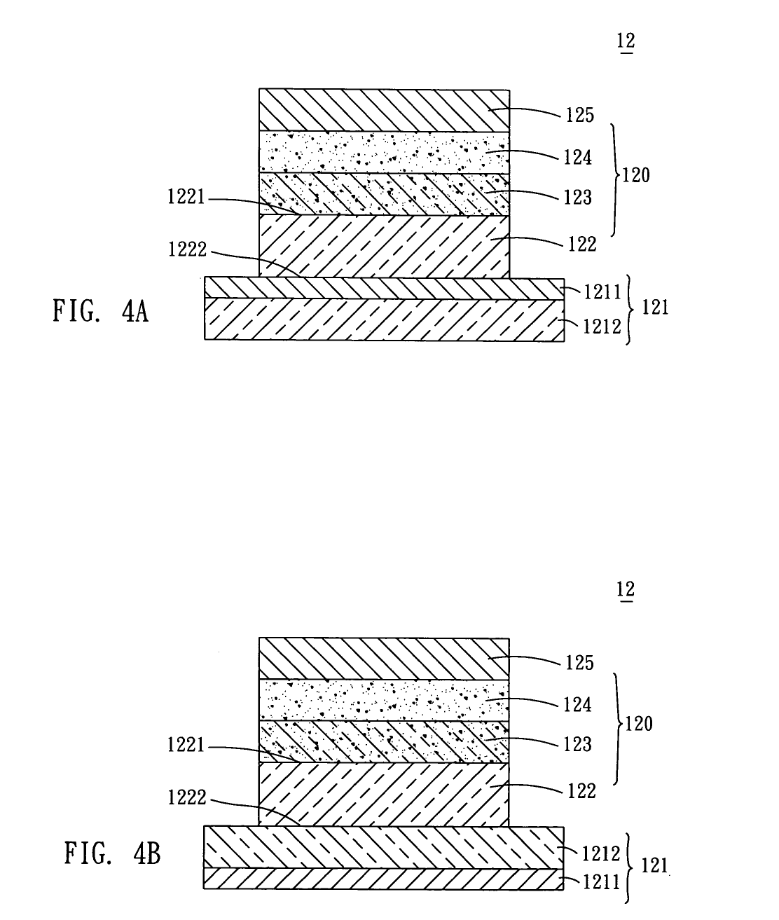

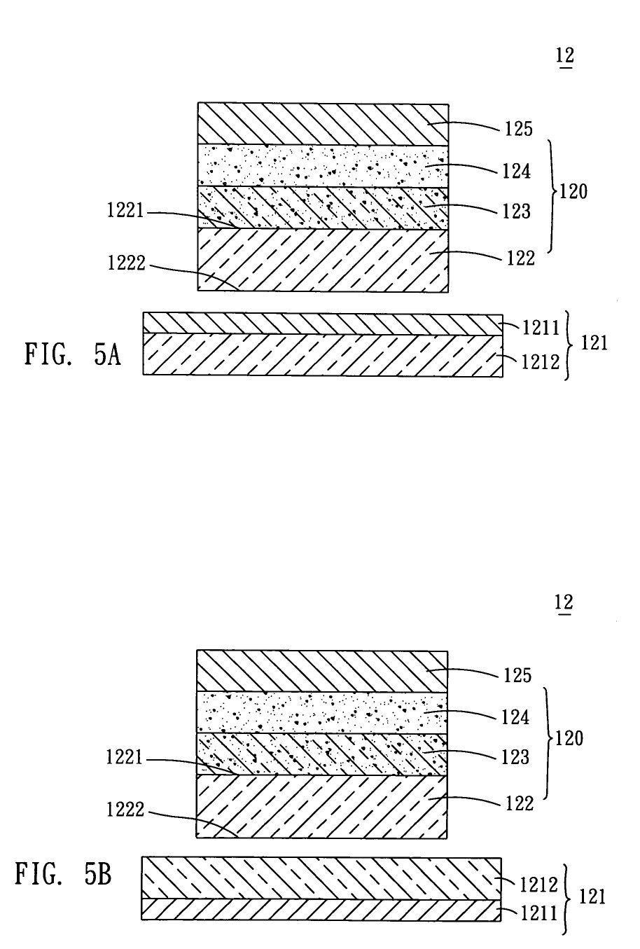

Referring to FIGS. 3, 4A and 5A, the electronic device 1 with a mirror function and an image capture function according to a first embodiment of this invention includes a body 11, a mirror display 12 and an image capture unit 13. The mirror display 12 is disposed in the body 11, and the mirror display 12 includes a mirror plate 121 and a display panel 120. The mirror plate 121 is combined with the display panel 120, as shown in FIG. 4A, or disposed near the display panel 120, as shown in FIG. 5A. A semi-reflecting layer 1211 is disposed above the mirror plate 121, and the image capture unit 13 is disposed in the body 11.

In this embodiment, the body 11 is a housing, and the shape and dimension of the body 11 may be adjusted according the requirement.

In this embodiment, the mirror display 12 may be an organic electroluminescent display.

The mirror display 12 of this embodiment is disposed in the body 11. As shown in FIG. 4A, the mirror display 12 includes the mirror plate 121, a transparent substrate 122, a first electrode 123, a light emitting region 124, and a second electrode 125. The transparent substrate 122 has a first surface 1221 and a second surface 1222 opposite to the first surface 1221. The first electrode 123 is disposed on the first surface 1221 of the transparent substrate 122, the second electrode 125 is disposed over the first electrode 123, the light emitting region 124 is disposed between the first electrode 123 and the second electrode 125, and the mirror plate 121 is combined with the second surface 1222 of the transparent substrate 122.

In this embodiment, the transparent substrate 122 may be a flexible substrate or a rigid substrate. Meanwhile, the transparent substrate 122 also may be a plastic substrate or a glass substrate. The flexible substrate and the plastic substrate may be a polycarbonate (PC) substrate, a polyester (PET) substrate, a cyclic olefin copolymer (COC) substrate or a metallocene-based cyclic olefin copolymer (mCOC) substrate.

As shown in FIG. 4A, the first electrode 123 is positioned on the first surface 1221 of the transparent substrate 122. In this embodiment, the first electrode 123 is formed on the transparent substrate 122 by way of sputtering or ion plating. Herein, the first electrode 123 usually serves as an anode and the material thereof is usually a transparent conductive metal oxide, such as the indium tin oxide (ITO), the aluminum zinc oxide (AZO), the indium zinc oxide (IZO), or the like.

In addition, the light emitting region 124, which may comprise an organic functional layer in this embodiment, is disposed on the first electrode 123. The organic functional layer usually includes a hole-injecting layer, a hole-transporting layer, a light-emitting layer, an electron-transporting layer and an electron-injecting layer (not shown). The organic functional layer is formed on the first electrode 123 by way of evaporation, spin coating, ink jet printing, printing, or the like. In addition, the light emitted from the organic functional layer may be blue, green, red, white or other monochromatic light, or the mixed light.

Referring to FIG. 4A again, the second electrode 125 is disposed on the organic functional layer. Herein, the second electrode 125 is formed on the organic functional layer by way of evaporation or sputtering. In addition, the material of the second electrode 125 may be one selected from the group consisting of, but not limited to, the Aluminum (Al), Calcium (Ca), Magnesium (Mg), Indium (In), Tin (Sn), Manganese (Mn), Silver (Ag), Gold (Au) and Magnesium-containing alloy (e.g., the Magnesium-Silver (Mg:Ag) alloy, Magnesium-Indium (Mg:In) alloy, Magnesium-Tin (Mg:Sn) alloy, Magnesium-Antimony (Mg:Sb) alloy, and Magnesium-Tellurium (Mg:Te) alloy), and the like.

In addition, referring to FIG. 4A again, the mirror plate 121 is combined with the second surface 1222 of the transparent substrate 122. The mirror plate 121 includes the semi-reflecting layer 1211 and a transparent plate 1212, and the semi-reflecting layer 1211 is disposed on the transparent plate 1212. As shown in FIG. 4A, the semi-reflecting layer 1211 is combined with the second surface 1222 of the transparent substrate 122. Furthermore, as shown in FIG. 4B, the transparent plate 1212 also may be sandwiched between the semi-reflecting layer 1211 and the transparent substrate 122.

In this embodiment, the transparent plate 1212 may be a flexible substrate or a rigid substrate. Meanwhile, the transparent plate 1212 also may be a plastic substrate or a glass substrate.

One side of the transparent plate 1212, which is close to the user, also may be provided with a camber or a composite line composing a camber and a straight line in order to increase the mirror function (e.g., wide viewing angle).

In this embodiment, the combining process may be performed by using the adhesive as well as an externally added fixing member (not shown) to fix the relative position between the mirror plate 121 and the transparent substrate 122. Herein, the area, dimension and shape of the mirror plate 121 may be adjusted according to the application requirement.

In this embodiment, the semi-reflecting layer 1211 is formed on the transparent plate 1212 by way of evaporation, sputtering, ion plating or adhering. In this embodiment, the material of the semi-reflecting layer 1211 is the metal or dielectric material. In addition, the transmission rate of the semi-reflecting layer 1211 is from 10% to 90%.

In addition, as shown in FIG. 5A, the mirror plate 121 of this embodiment also may be adjacent to the second surface 1222 of the transparent substrate 122, and the relative position between the mirror plate 121 and the transparent substrate 122 is fixed using a fixing member (not shown). The semi-reflecting layer 1211 is adjacent to the second surface 1222 of the transparent substrate 122, as shown in FIG. 5A. Furthermore, as shown in FIG. 5B, the transparent plate 1212 also may be sandwiched between the semi-reflecting layer 1211 and the transparent substrate 122.

In this embodiment, when the mirror display 12 is emitting light, the user can see information such as characters, numbers, images, or videos, displayed on the mirror display 12. On the other hand, when the mirror display 12 is not emitting light, it only reflects images like a mirror without showing any information or other images. That is, the mirror display 12 serves as a mirror.

In addition, the mirror display 12 of this embodiment also may be an electroluminescence (EL) display, a light-emitting diode (LED) display, a liquid crystal display (LCD), a plasma display panel (PDP), a vacuum fluorescent display (VFD), a field emission display (FED) or an electro-chromic display.

Referring to FIG. 3 again, the image capture unit 13 of this embodiment is disposed in the body 11. Herein, the image capture unit 13 includes a lens and a charge coupled device (CCD) or CMOS, wherein the CCD is a sensor through which the image captured by the lens is converted into the digital image or signal. Then, the digital image can be stored in storage media, like memory card, through optoelectronic processing media.

In addition, the electronic device 1 of this embodiment further includes an input unit 14 disposed in the body 11. The input unit 14 may be a keyboard input unit, a touch panel input unit or a voice-controlled input unit. Herein, the input unit 14 is adjacent to the mirror display 12. Of course, the input unit 14 also may be disposed on the mirror display 12 (not shown).

In addition, the electronic device 1 of this embodiment further includes an information processing module (not shown) set in the body 11. Herein, the information processing module includes a microprocessor, a communication interface (transmitter/receiver), a memory and a signal processor.

In addition, the electronic device 1 of this embodiment further includes a power supply unit, such as a battery (not shown), disposed in the body 11.

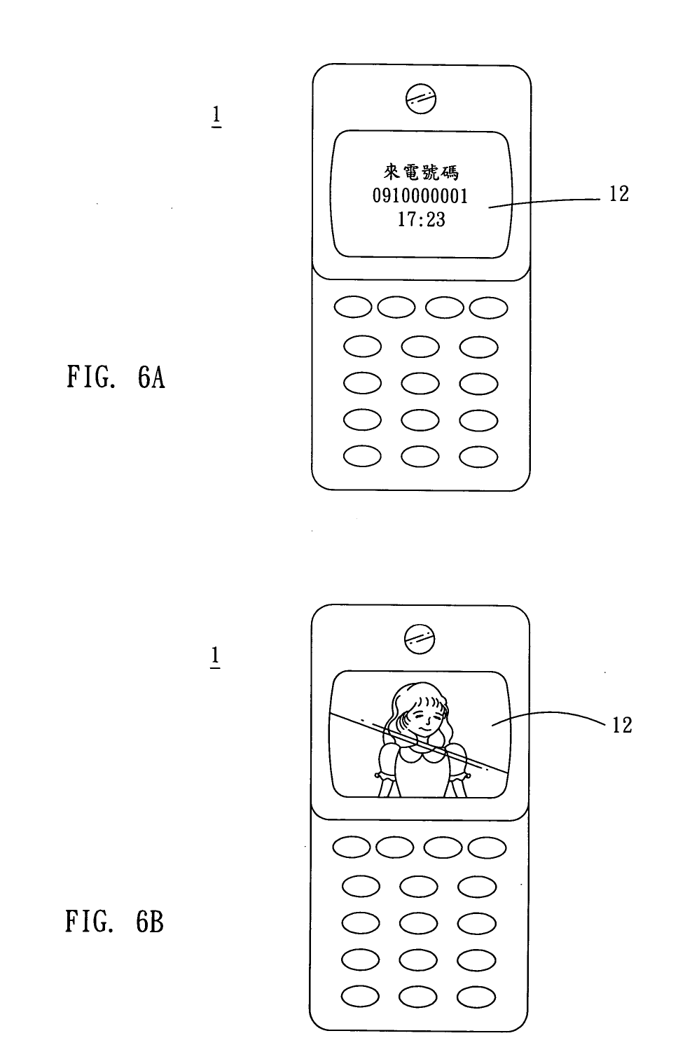

FIGS. 6A and 6B show an arrangement of embodied schematic illustrations of FIG. 3. As shown in FIG. 6A, when the mirror display 12 is emitting light, the mirror display 12 has the function of showing the information or images, such as the telephone caller ID, time or other images. On the other hand, as shown in FIG. 6B, when the mirror display 12 is not emitting light, the mirror display 12 has the function as an image reflective mirror. So, when the user utilizes the electronic device 1 to photograph himself/herself, his/her reflected image may be seen in the mirror display 12. That is, the image captured by the mirror display serves as a image preview.

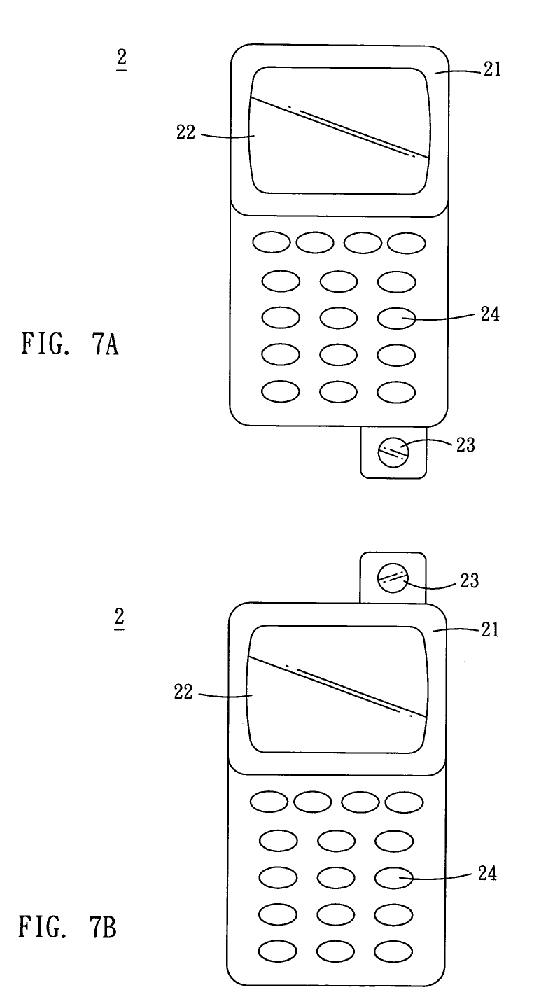

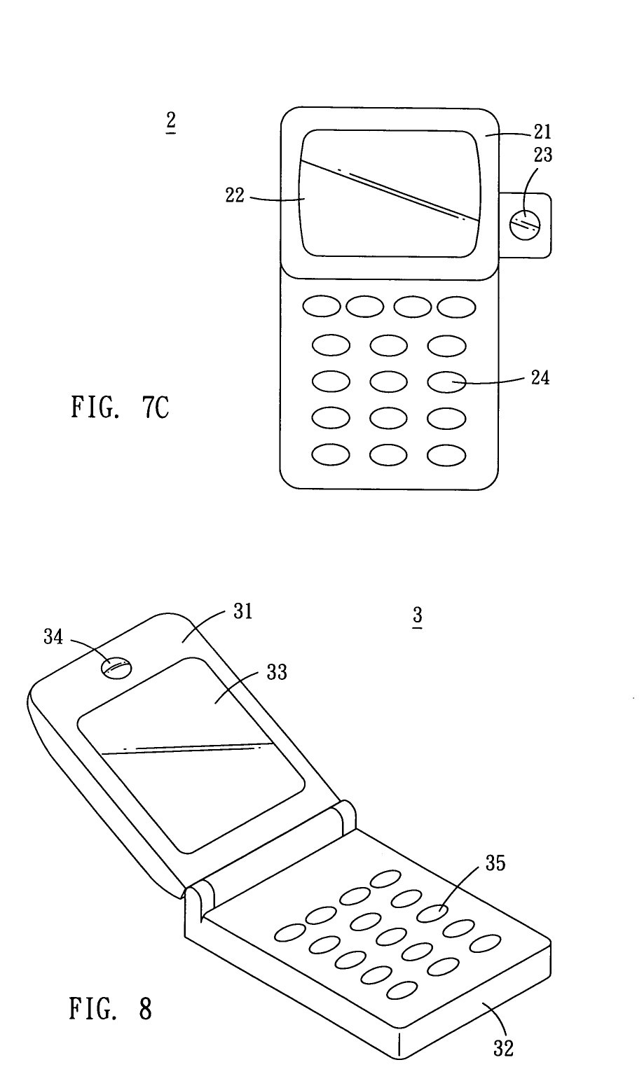

In addition, referring to FIGS. 7A, 7B, and 7C, the electronic device 2 with a mirror function and an image capture function according to the second embodiment of this invention includes a body 21, a mirror display 22, and an image capture unit 23. The mirror display 22 is disposed in the body 21, and the mirror display 22 includes a mirror plate and a display panel. The mirror plate is combined with or disposed near the display panel, and a semi-reflecting layer is disposed above the mirror plate. The image capture unit 23 is connected to a side of the body 21.

As shown in FIGS. 7A, 7B, and 7C, the image capture unit 23 of this embodiment is connected to a side of the body 21, and the position of the image capture unit 23 may be adjusted according to the practical requirement.

In addition, the characteristics and functions of the body 21, the mirror display 22 and the image capture unit 23 of this embodiment are the same as those of the first embodiment, and detailed descriptions thereof will be omitted.

The electronic device 2 of this embodiment further includes an input unit 24, an information processing module (not shown), and a power supply unit (not shown), wherein the characteristics and functions of the components are the same as those of the first embodiment, and detailed descriptions thereof will be omitted.

In addition, as shown in FIG. 8, the electronic device 3 with mirror function and image capture function according to the third embodiment of this invention includes a first body 31, a second body 32, a mirror display 33 and an image capture unit 34. The second body 32 and the first body 31 are connected to each other, the mirror display 33 is disposed in first body 31, and the mirror display 33 includes a mirror plate and a display panel. The mirror plate is combined with or disposed near the display panel, and a semi-reflecting layer is disposed above the mirror plate. The image capture unit 34 is disposed in first body 31 or the second body 32 (not shown).

In this embodiment, the first body 31 and the second body 32 are the housing, and the shape and dimension of each of the first body 31 and the second body 32 may be adjusted according to the requirement. As shown in FIG. 8, the first body 31 and the second body 32 are connected to each other by way of, for example, pivoting. Of course, the pivot of this embodiment also may be disposed in one of the other three sides (not shown). In addition, the first body 31 and the second body 32 also may be replaced with each other.

In addition, the characteristics and functions of the mirror display 33, the mirror plate, the display panel and the semi-reflecting layer of this embodiment are the same as those of the first embodiment, and detailed descriptions thereof will be omitted.

The electronic device 3 of this embodiment further includes an input unit 35, an information processing module (not shown) and a power supply unit (not shown), wherein the characteristics and functions of the components are the same as those of the first embodiment, and detailed descriptions thereof will be omitted.

Referring again to FIG. 8, except for that the image capture unit 34 is disposed in first body 31 in this embodiment, other characteristics and functions of image capture unit 34 are the same as those of the image capture unit 13 of the first embodiment, and detailed descriptions thereof will be omitted.

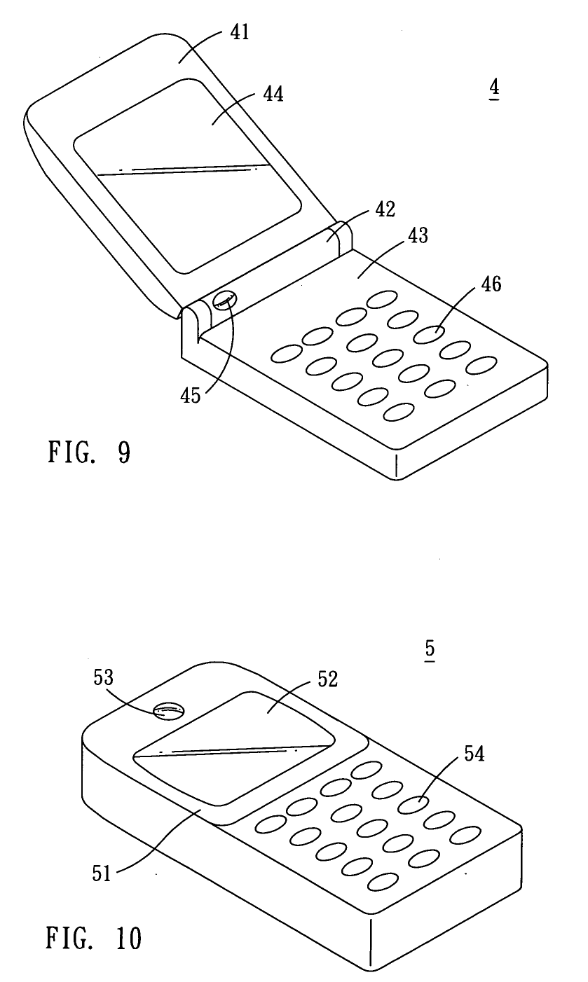

In addition, as shown in FIG. 9, the electronic device 4 with a mirror function and an image capture function according to the fourth embodiment of this invention includes a first body 41, a pivot 42, a second body 43, a mirror display 44 and an image capture unit 45. The second body 43 and the first body 41 are connected to each other through the pivot 42. The mirror display 44 is disposed in first body 41 and includes a mirror plate and a display panel. The mirror plate is combined with or disposed near the display panel and a semi-reflecting layer is disposed above the mirror plate. The image capture unit 45 is disposed in the pivot 42.

In this embodiment, the characteristics and functions of the first body 41, the second body 43, the mirror display 44, the mirror plate, the semi-reflecting layer and the display panel are the same as those of the first embodiment, and detailed descriptions thereof will be omitted.

In addition, as shown in FIG. 9, except for that the image capture unit 45 is disposed in the pivot 42 in this embodiment, other characteristics and functions of the image capture unit 45 are the same as those of the image capture unit 13 of the first embodiment, and detailed descriptions thereof will be omitted.

The electronic device 4 of this embodiment further includes an input unit 46, an information processing module (not shown) and a power supply unit (not shown), all of which have the same characteristics and functions as those of the first embodiment, and detailed descriptions thereof will be omitted.

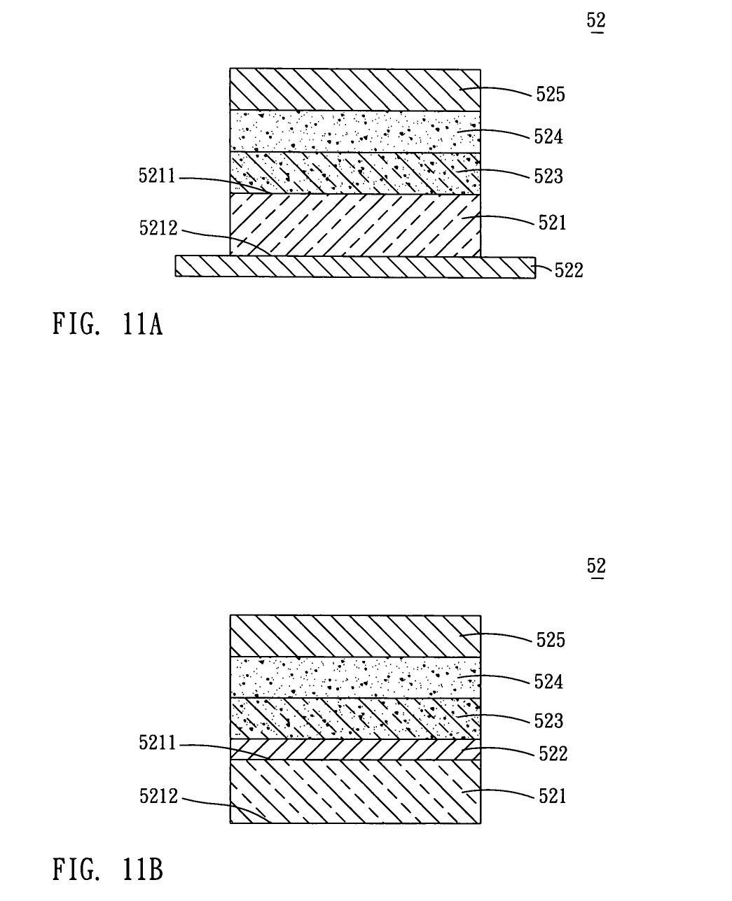

In addition, referring to FIGS. 10, 11A and 11B, the electronic device 5 with a mirror function and an image capture function according to the fifth embodiment of this invention includes a body 51, a mirror display 52 and an image capture unit 53. The mirror display 52 is disposed in the body 51 and includes a transparent substrate 521 and a semi-reflecting layer 522, which has a first surface 5211 and a second surface 5212 opposite to the first surface 5211. The semi-reflecting layer 522 is disposed above the first surface 5211 or the second surface 5212, and the image capture unit 53 is disposed in the body 51.

In this embodiment, the mirror display 52 may be an organic electroluminescent display.

The mirror display 52 of this embodiment is disposed in first body 51. As shown in FIG. 11A, the mirror display 52 includes a transparent substrate 521, a semi-reflecting layer 522, a first electrode 523, a light emitting region 524 and a second electrode 525. The transparent substrate 521 has the first surface 5211 and the second surface 5212 opposite to the first surface 5211. The first electrode 523 is disposed on the first surface 5211 of the transparent substrate 521, the second electrode 525 is disposed over the first electrode 523, and the light emitting region 524 is disposed between the first electrode 523 and the second electrode 525. The semi-reflecting layer 522 is disposed on the second surface 5212, and the light emitting region 524 may comprise an organic functional layer.

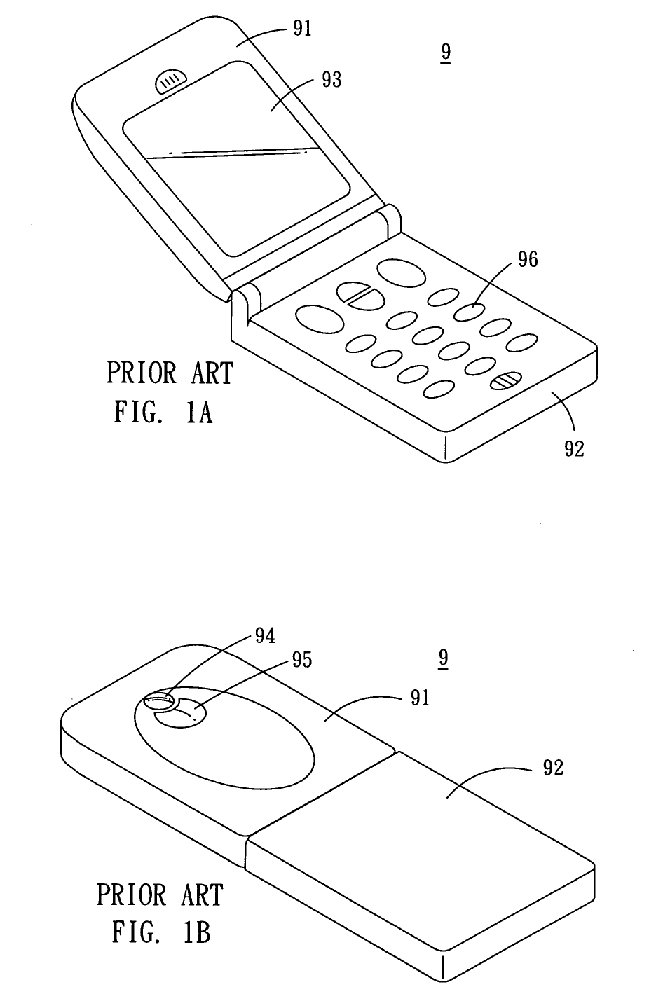

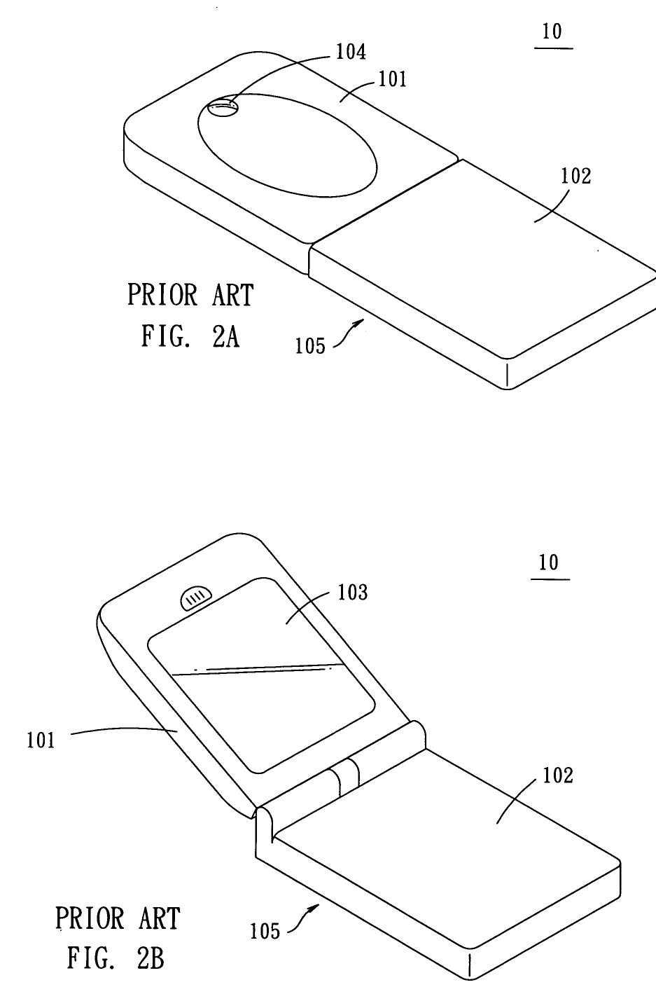

As shown in FIG. 1A, the semi-reflecting layer 522 is disposed on the second surface 5212. Herein, the semi-reflecting layer 522 is formed on the second surface 5212 by way of evaporation, sputtering or ion plating In this embodiment, the material of the semi-reflecting layer 522 is the metal or dielectric material. In addition, the transmission rate of the semi-reflecting layer 522 is from 10% to 90%.

Of course, the semi-reflecting layer 522 also may be disposed on the first surface 5211, as shown in FIG. 11B.

In this embodiment, when the material of the semi-reflecting layer 522 is the metal, an insulation layer (not shown) is further disposed between the semi-reflecting layer 522 and the first electrode 523. The insulation layer is a transparent substance for isolating the semi-reflecting layer 522 from the first electrode 523 and thus avoiding the short-circuited condition due to the contact therebetween.

In addition, the characteristics and functions of the body 51, the transparent substrate 521, the semi-reflecting layer 522, the first electrode 523, the organic functional layer 524, the second electrode 525 and the image capture unit 53 in this embodiment are the same as those of the first embodiment, and detailed descriptions thereof will be omitted.

The electronic device 5 of this embodiment further includes an input unit 54, an information processing module (not shown) and a power supply unit (not shown), all of which have the same characteristics and functions as those of the first embodiment, and detailed descriptions thereof will be omitted.

In addition, the mirror display 52 of this embodiment also may be EL display, LED display, LCD, PDP, VFD, FED or electro-chromic display.

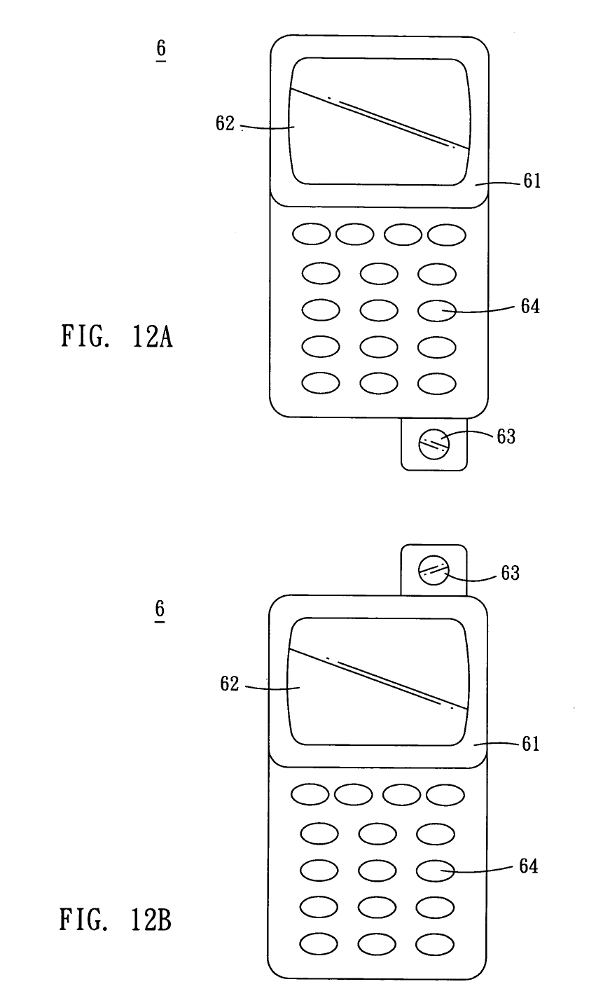

In addition, referring to FIGS. 12A, 12B, and 12C, the electronic device 6 with a mirror function and an image capture function according to the sixth embodiment of this invention includes a body 61, a mirror display 62, and an image capture unit 63. The mirror display 62 is disposed in the body 61 and includes a transparent substrate and a semi-reflecting layer. The transparent substrate has a first surface and a second surface opposite to the first surface, the semi-reflecting layer is disposed above the first or second surface, and the image capture unit 63 is connected to a side of the body 61.

In this embodiment, the characteristics and functions of the body 61, the mirror display 62, the transparent substrate and the semi-reflecting layer are the same as those of the fifth embodiment, and detailed descriptions thereof will be omitted.

Except for that the image capture unit 63 of this embodiment is connected to a side of the body 61, other characteristics and functions of the image capture unit 63 are the same as those of the image capture unit 53 of the fifth embodiment, and detailed descriptions thereof will be omitted.

The electronic device 6 of this embodiment further includes an input unit 64, an information processing module (not shown) and a power supply unit (not shown), all of which have the same characteristics and functions as those of the first embodiment, and detailed descriptions thereof will be omitted.

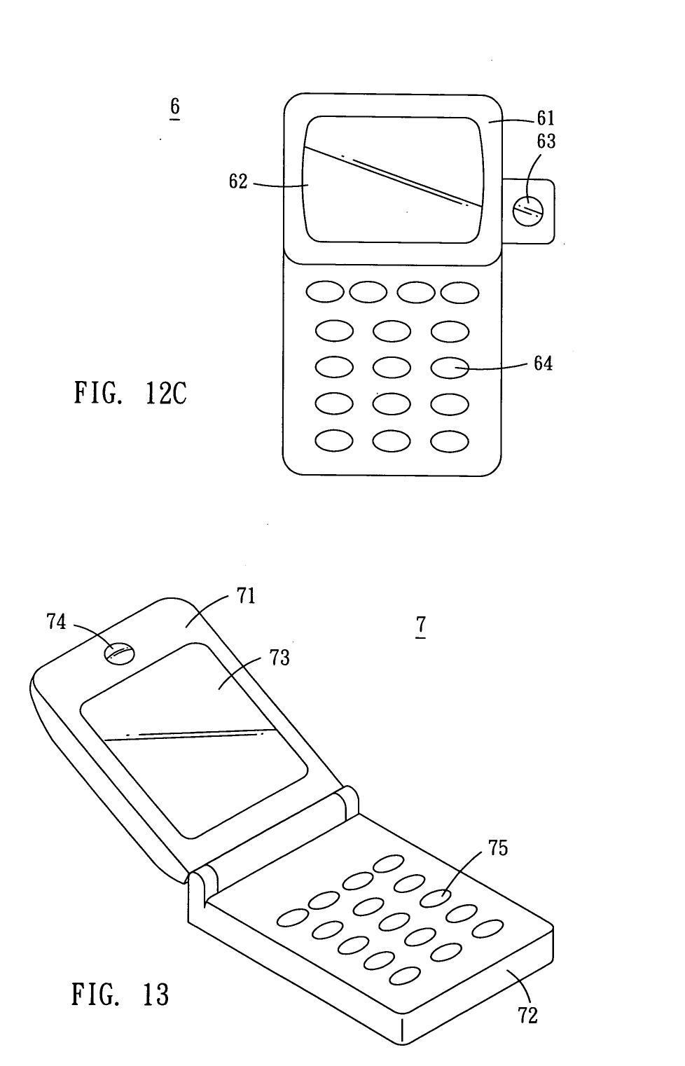

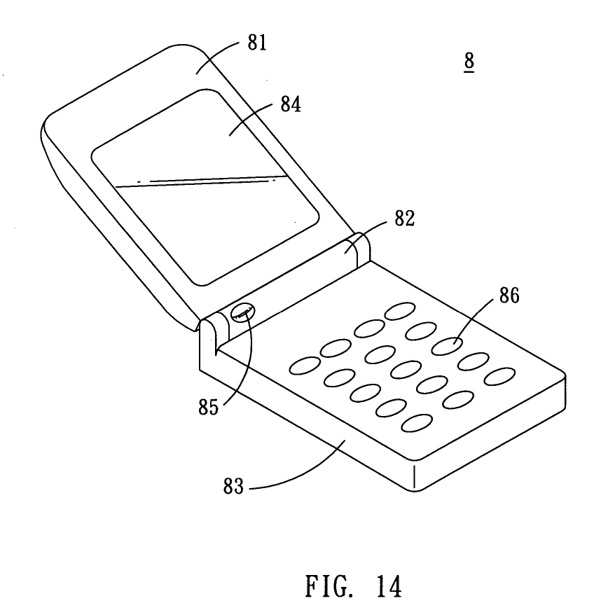

In addition, referring to FIG. 13, the electronic device 7 with a mirror function and an image capture function according to the seventh embodiment of this invention includes a first body 71, a second body 72, a mirror display 73 and an image capture unit 74. The second body 72 and the first body 71 are connected to each other. The mirror display 73 is disposed in first body 71 and includes a transparent substrate and a semi-reflecting layer. The transparent substrate has a first surface and a second surface opposite to the first surface. The semi-reflecting layer is disposed above the first or second surface, and the image capture unit 74 is disposed in the first body 71 or the second body 72 (not shown).

In this embodiment, the characteristics and functions of the first body 71 and the second body 72 are the same as those of the third embodiment, and detailed descriptions thereof will be omitted.

In addition, the characteristics and functions of the mirror display 73, the transparent substrate, the semi-reflecting layer and the image capture unit 74 are the same as those of the fifth embodiment, and detailed descriptions thereof will be omitted.

The electronic device 7 of this embodiment further has an input unit 75, an information processing module (not shown) and a power supply unit (not shown), all of which have the same characteristics and functions as those of the first embodiment, and detailed descriptions thereof will be omitted.

In addition, referring to FIG. 14, the electronic device 8 with a mirror function and an image capture function according to the eighth embodiment of this invention includes a first body 81, a pivot 82, a second body 83, a mirror display 84 and an image capture unit 85. The second body 83 and the first body 81 are connected to each other through the pivot 82. The mirror display 84 is disposed in first body 81 and includes a transparent substrate and a semi-reflecting layer. The transparent substrate has a first surface and a second surface opposite to the first surface. The semi-reflecting layer is disposed above the first or the second surface, and the image capture unit 85 is disposed in the pivot 82.

In this embodiment, the characteristics and functions of the first body 81, the pivot 82, the second body 83, the mirror display 84, the transparent substrate, the semi-reflecting layer and the image capture unit 85 are the same as those of the seventh embodiment, and detailed descriptions thereof will be omitted.

As shown in FIG. 14, except for that the image capture unit 85 is disposed in the pivot 82 in this embodiment, other characteristics and functions of the image capture unit 85 are the same as those of the image capture unit 13 of the first embodiment, and detailed descriptions thereof will be omitted.

The electronic device 8 of this embodiment further includes an input unit 86, an information processing module (not shown) and a power supply unit (not shown), all of which have the same characteristics and functions as those of the first embodiment, and detailed descriptions thereof will be omitted.

Of course, in this invention, the electronic device includes, but not limited to, a mobile phone, a hand-held PC, a personal digital assistant (PDA), an e-book, a stock quote machine, a digital voice recorder, a digital still camera, or a digital video recorder (DVR).

The electronic device of this invention with a mirror function and an image capture function utilizes the mirror display for the image preview. More specifically, when the user utilizes the electronic device to photograph his/her own image, the reflection function of the mirror display may be utilized to make sure targeted image is correctly framed and focused. Compared to the prior art, the image framing and preview can be done at the same time without any other assisting part or module, e.g., the metallic convex mirror in the prior art, in this invention. Thus, this invention provides a lower manufacturing cost with less complicated image capture operations. Also, this invention can provide precise image preview without utilizing any other display to demonstrate. In addition, when the mirror display is disabled from emitting light, the mirror display of the electronic device has the function of image reflecting mirror, which may reflect the user's own image for the purpose of image preview. On the other hand, when the mirror display is emitting light, the mirror display of the electronic device has the function of displaying the information and images and may serve as the typical display. Furthermore, this invention can possess the mirror function by only providing the semi-reflecting layer in the mirror display. Thus, the manufacturing processes are simple and the manufacturing cost are decreased. This invention is very feasible for practical mass production.

While this invention has been described by way of examples and in terms of preferred embodiments, it is to be understood that this invention is not limited to the disclosed embodiments. To the contrary, it is intended to cover various modifications. Therefore, the scope of the appended claims should be accorded the broadest interpretation so as to encompass all such modifications.

What is claimed is:

1. An electronic device with a mirror function and an image capture function, comprising:
a body;
a mirror display, which is disposed in the body and comprises a mirror plate and a display panel, wherein the mirror plate is combined with the display panel or disposed near the display panel, and a semi-reflecting layer is disposed above the mirror plate; and
an image capture unit, which is disposed in the body or connected to a side of the body.

2. The electronic device according to claim 1, further comprising an input unit disposed in the body.

3. The electronic device according to claim 2, wherein the input unit is adjacent to the mirror display or the input unit is disposed on the mirror display.

4. The electronic device according to claim 1, further comprising an information processing module disposed in the body.

5. The electronic device according to claim 1, wherein the mirror plate further comprises a transparent plate, and the semi-reflecting layer is disposed above or on the transparent plate.

6. The electronic device according to claim 1, wherein the semi-reflecting layer is made of metal or dielectric material.

7. The electronic device according to claim 1, wherein the transmission rate of the semi-reflecting layer is from 10% to 90%.

8. The electronic device according to claim 1, wherein the display panel is one selected from the group consisting of organic electroluminescence (OEL) display panel, electroluminescence (EL) display panel, light-emitting diode (LED) display panel, liquid crystal display (LCD), plasma display panel (PDP), vacuum fluorescent display (VFD), field emission display (FED), and electro-chromic display.

9. An electronic device with a mirror function and an image capture function, comprising:
a first body;
a pivot;
a second body connected to the first body through the pivot;
a mirror display, which is disposed in first body and comprises a mirror plate and a display panel, wherein the mirror plate is combined with or disposed near the display panel, and a semi-reflecting layer is disposed above the mirror plate; and
an image capture unit that is disposed in the pivot, the first body or the second body.

10. The electronic device according to claim 9, further comprising an input unit that is disposed in the first body or the second body.

11. The electronic device according to claim 10, wherein the input unit is adjacent to the mirror display or disposed on the mirror display.

12. The electronic device according to claim 9, wherein the mirror plate further comprises a transparent plate, the semi-reflecting layer is disposed above or on the transparent plate.

13. The electronic device according to claim 9, wherein the semi-reflecting layer is made of metal or dielectric material.

14. The electronic device according to claim 9, wherein the transmission rate of the semi-reflecting layer is from 10% to 90%.

15. An electronic device with a mirror function and an image capture function, comprising:
a body;
a mirror display, which is disposed in the body and comprises a transparent substrate and a semi-reflecting layer, wherein the transparent substrate has a first surface and a second surface opposite to the first surface, and the semi-reflecting layer is disposed above the first surface or the second surface; and
an image capture unit which is disposed in the body or connected to a side of the body.

16. The electronic device according to claim 15, further comprising an input unit that is disposed in the body.

17. The electronic device according to claim 16, wherein the input unit is adjacent to the mirror display or disposed on the mirror display.

18. The electronic device according to claim 15, wherein the semi-reflecting layer is made of metal or dielectric material.

19. The electronic device according to claim 15, wherein the transmission rate of the semi-reflecting layer is from 10% to 90%.

20. The electronic device according to claim 15, wherein the body comprises a first body and a second body, both of which are connected to each other through a pivot.
